(19) United States
(12) Patent Application Publication
(10) Pub. No.: US 2004/0019595 A1
(43) Pub. Date: Jan. 29, 2004

(54) Method, apparatus, and program for knowledge base externalization and tracking

(75) Inventors: Kulvir Singh Bhogal, Fort Worth, TX (US); David J. Carew, Austin, TX (US); Hung The Dinh, Round Rock, TX (US); Teng S. Hu, Austin, TX (US); Mansoor A. Lakhdhir, Austin, TX (US); Narendra N. Reddy, Austin, TX (US); Mandeep Singh Sidhu, Pflugerville, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/202,765

(22) Filed: Jul. 25, 2002

(51) Int. Cl. G06F 7/00

(52) U.S. Cl. 707/10

(57) ABSTRACT

A mechanism is provided for externalization, publication, and tracking of knowledge entries in a knowledge database. When a knowledge entry document is created, it is routed to a reviewer's work queue. If the reviewer approves the knowledge entry, it is automatically published to the knowledge base. If the reviewer rejects the knowledge entry, it is sent back to the author. The author may then make changes and resubmit the knowledge entry document or delete the knowledge entry from the system. When a knowledge entry document is published to the knowledge base, it is time stamped with an expiration date. When the knowledge entry expires, it is routed to the original author's revalidation queue. If the author accepts the knowledge entry, the expiration date is reset and the knowledge entry document is returned to the knowledge base. If the author rejects the knowledge entry, it is routed to the author's work queue. The author may then rework the document and return it or delete the knowledge entry from the system. A variety of reports may be run, depending on the implementation.

### BACKGROUND OF THE INVENTION

1. Technical Field

The present invention relates to data processing and, in particular, to creation and tracking of frequently-asked-questions and hints-and-tips documents. Still more particularly, the present invention provides a method, apparatus, and program for externalization and tracking of knowledge entries in a knowledge base.

2. Description of Related Art

Many companies post frequently-asked-questions (FAQ) documents and hints-and-tips (HAT) documents in a knowledge base for access by customers. A FAQ document is a group of commonly asked questions about a subject along with the answers. FAQ documents may be used to augment the description of a product, thus allowing customers to get answers to questions without calling technical support. An HAT document provides hints and tips for a product, thus allowing a customer to conveniently receive information for using a product more effectively. Other documents that may be included in a knowledge base include troubleshooting documents, error description documents, etc.

These documents may be posted on a company Web site with an interface for searching the knowledge base. The number of customers that are Internet aware and willing to access knowledge bases online is increasing. As more customers access these documents online, the number of support telephone calls that these customers are likely to generate will decrease. Therefore, online FAQ and HAT documents, if managed correctly, may improve customer satisfaction with a product and reduce support costs for the company.

When a knowledge base volume of a company becomes large, as is common with many large companies that support a myriad of products, the maintenance issues arise. To manually maintain a large knowledge database becomes a laborious effort. For example, one may wish to maintain reports regarding the number of entries created or deleted or the number of entries created by a particular department or person. One must also revalidate older knowledge base entries to ensure the customer base is receiving the most up-to-date information possible. In addition, one must remove knowledge base entries that are no longer needed or obsolete. One may also wish to review documents, such as for technical accuracy, grammar, and spelling, before publishing.

Therefore, it would be advantageous to provide an improved mechanism for managing a knowledge database.

### SUMMARY OF THE INVENTION

The present invention provides a mechanism for externalization, publication, and tracking of knowledge entries in a knowledge database. When a knowledge entry document is created, it is routed to a reviewer's work queue. If the reviewer approves the knowledge entry, it is automatically published to the knowledge base. If the reviewer rejects the knowledge entry, it is sent back to the author. The author may then make changes and resubmit the knowledge entry document or delete the knowledge entry from the system.

When a knowledge entry document is published to the knowledge base, it is time stamped with an expiration date. When the knowledge entry expires, it is routed to the original author's revalidation queue. If the author accepts the knowledge entry, the expiration date is reset and the knowledge entry document is returned to the knowledge base. If the author rejects the knowledge entry, it is routed to the author's work queue. The author may then rework the document and return it or delete the knowledge entry from the system.

An author may receive credit for creation of a knowledge entry. If a knowledge entry document is published, then the author may receive externalization credit. A variety of reports may be run, depending on the implementation. An administrator may monitor and maintain the knowledge externalization and tracking system. The administrator may create and delete users from the system, reset user passwords, or set reviewer permissions to allow a few select users to be reviewers.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing system in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is an exemplary block diagram of a knowledge base externalization and tracking system in accordance with a preferred embodiment of the present invention;

FIGS. 5A and 5B are block diagrams illustrating the operation of a knowledge base externalization and tracking system in accordance with a preferred embodiment of the present invention;

FIG. 6 is a flowchart of the operation of a reviewer device in accordance with a preferred embodiment of the present invention; and

FIG. 7 is a flowchart of the operation of an author device in accordance with a preferred embodiment of the present invention.

### DETAILED DESCRIPTION OF THE PREFERRED EMBODIMENT

With reference now to the figures, FIG. 1 depicts a pictorial representation of a network of data processing system in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 and provides access to knowledge base 106. In addition, clients 108, 110, and 112 are connected to network 102. These clients 108, 110, and 112 may be, for example, personal computers or network computers. In the depicted example, server 104 provides data, such as knowledge entry documents in knowledge base 106, to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

In accordance with a preferred embodiment of the present invention, authors may operate clients, such as clients 108, 110, 112, to create documents for knowledge base 106. Upon creation, knowledge entry documents may be routed to a reviewer 120 for approval and subsequent publishing to knowledge base 106. Knowledge entry documents may include, for example, FAQ documents, HAT documents, troubleshooting documents, and the like. The knowledge base may be accessed outside the company via server 104. Server 104 may be, for example, a Web server. Since knowledge entries may be accessed outside the company when published to the knowledge base, publication is referred to as “externalization.”

Administrator 122 may monitor and maintain network data processing system 100. The administrator may create and delete users from the system, reset user passwords, or set reviewer permissions to allow a few select users to be reviewers.

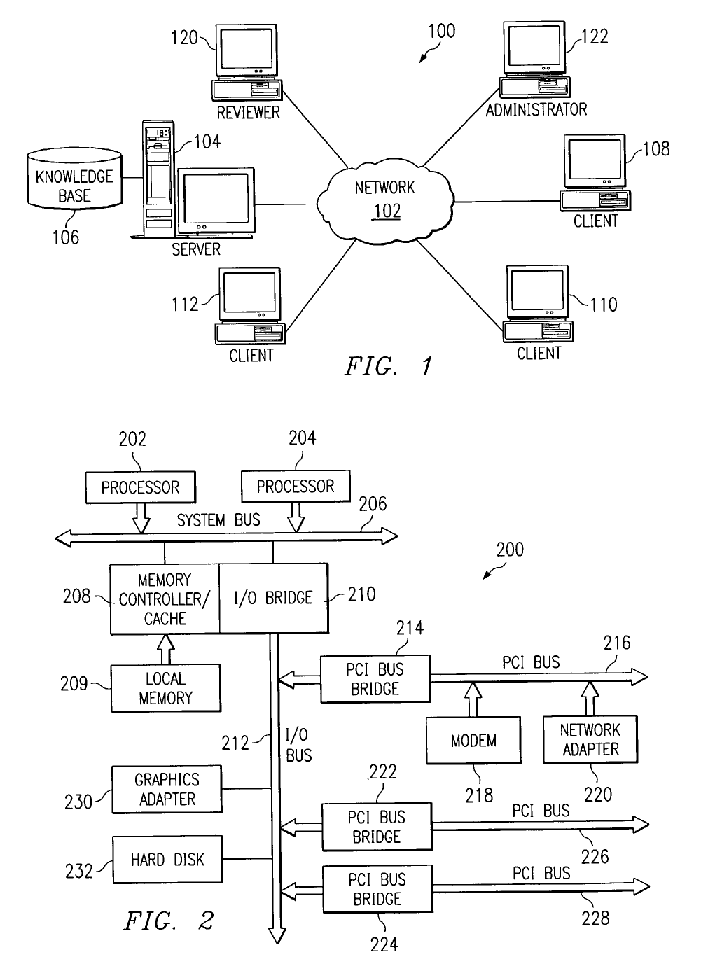

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

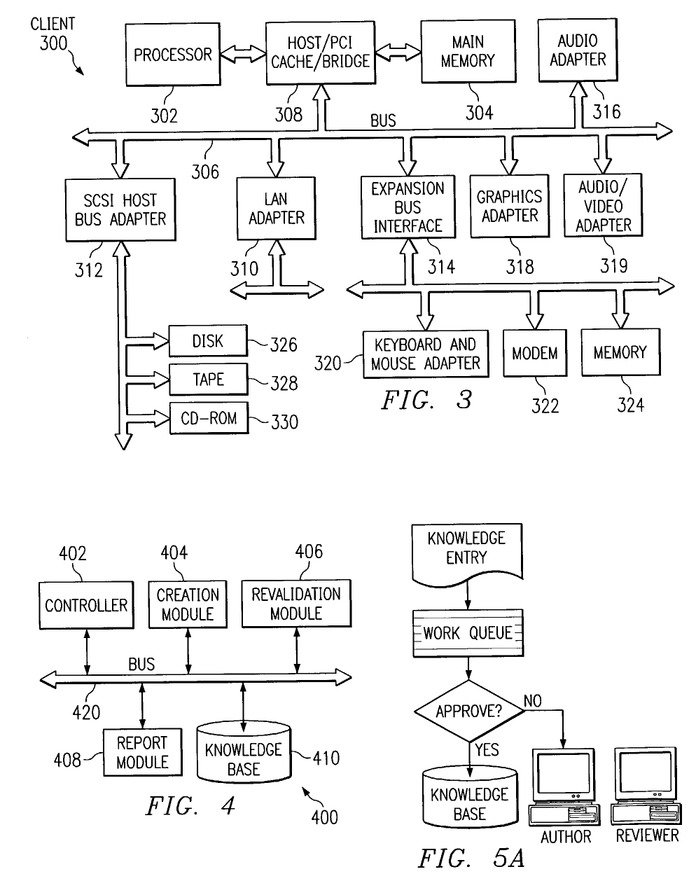

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is an exemplary block diagram of a knowledge base externalization and tracking system in accordance with a preferred embodiment of the present invention. Knowledge base externalization and tracking system 400 includes controller 402, creation module 404, revalidation module 406, reporting module 408, and knowledge base 410. The elements 402-410 may be implemented as hardware, software, or a combination of hardware and software. In a preferred embodiment, the elements 404-410 are implemented as software instructions executed by one or more processors. Knowledge base externalization and tracking system 400 may comprise software running on a server, such as server 104 in FIG. 1.

The elements 402-410 are coupled to one another via the control/data signal bus 410. Although a bus architecture is shown in FIG. 4, the present invention is not limited to such. Rather, any architecture that facilitates the communication of control/data signals between elements 402-410 may be used without departing from the spirit and scope of the present invention. The controller 402 controls the overall operation of the knowledge base externalization and tracking system and orchestrates the operation of the other elements 404-410.

With the operation of the present invention, creation module 404 instructs controller 402 to receive knowledge entry documents and route them to a reviewer. Creation module 404 may also include a graphical user interface (GUI) for creation of a knowledge base entry by an author. The reviewer may then decide whether the knowledge entry document is published or returned to the author. Revalidation module 406 instructs the controller to receive expired knowledge entry documents and route them to the appropriate author for revalidation.

Reporting module 408 instructs the controller to run various reports to track submission, externalization, and revalidation of knowledge entries. An author may receive credit for the creation of a knowledge entry. This is ideal for companies that require employees to be proactively involved in the customer support part of the business. If a knowledge entry gets externalized, then the author may receive externalization credit. A variety of reports may be run, depending on the implementation and desired results. For example, the reporting module may produce reports by department, individual user, technology area, etc.

Thus, a submission report may detail the number of knowledge entries submitted by a user, department, or technology area. For example, a submission report may reveal that an operating system department of a software company submits more knowledge entries than an application department.

An externalization report may identify the number of knowledge entries that are actually externalized. For example, an individual user, department, or technology area may submit many knowledge entries with very few of them ultimately being externalized.

A revalidation report may detail expired knowledge entries and whether they continue to be externalized. In addition, a user may be allowed to provide comments or select a reason for rejection of a knowledge entry. Thus, the revalidation report may provide information as to the number of knowledge entries that are rejected for various reasons. For example, a revalidation report may identify the number of knowledge entries that become obsolete due to products no longer being supported. A revalidation report may also contain information about the revalidation of knowledge entries by individual user, department, or technology area. Thus, users may be rewarded for reworking and updating expired knowledge entries.

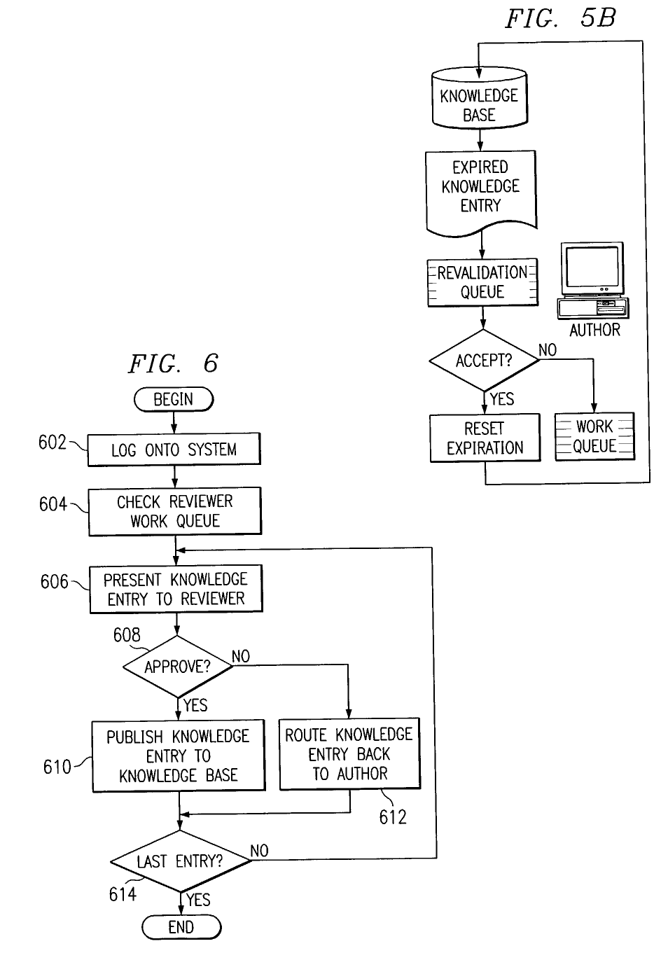

With reference now to FIGS. 5A and 5B, block diagrams illustrating the operation of a knowledge base externalization and tracking system are shown in accordance with a preferred embodiment of the present invention. More particularly, FIG. 5A illustrates knowledge entry creation in the knowledge base externalization and tracking system of the present invention. A knowledge entry is created by an author. The author may create the knowledge entry using a GUI in the knowledge base externalization and tracking system.

The knowledge entry is routed to an appropriate reviewer's work queue. The next time the reviewer logs onto the knowledge base externalization and tracking system, the new knowledge base entry will be present in the work queue. If the reviewer approves the knowledge entry, the document is automatically published to the knowledge base for access through the company Web site.

If the reviewer rejects the knowledge entry, it is pushed back to the author. The author may then make changes to the knowledge entry and resubmit it for review. Alternatively, the author may simply delete the knowledge entry from the system.

Turning to FIG. 5B, a block diagram illustrates knowledge entry revalidation in the knowledge base externalization and tracking system of the present invention. When a knowledge entry document is published, it is time stamped with an expiration date. When the knowledge entry expires, it is routed to the original author's revalidation queue. The next time the author logs into the knowledge base externalization and tracking system, the expired knowledge base entry will be present in the revalidation queue.

If the author accepts the knowledge entry, the expiration date is reset to a later date and the knowledge entry document is returned to the knowledge base. If the author does not accept the knowledge entry, it is routed to the author's work queue. The author can then rework the knowledge entry document back into externalization or simply delete it.

Data regarding the queue are stored in a database at the server, such as data storage 106 in FIG. 1. Alternatively, the queue data, log-on data, and the like may also be stored at a separate server in the network data processing system. The queues are dynamically built based on the data of the meta data of the knowledge entries and the information of the log-on user. The queues may store pointers or references to documents in the knowledge base. The knowledge base may also include both externalized and non-externalized documents.

Thus, when a user logs onto the system, the server, such as server 104, may authenticate the user. Then, the work queue and/or revalidation queue on the server may be accessed by the user. The queues may store information about the knowledge entries and references to the actual documents in the knowledge base. When a user selects a knowledge entry for processing, such as by using a graphical user interface (GUI) (not shown), the document may be retrieved from the knowledge base. The GUI may be a single integrated interface that allows the user to, for example, switch between a work queue and a revalidation queue, view and edit documents, quickly and easily approve or reject a knowledge item, etc. Alternatively, the system may include separate interfaces for work queues and revalidation queues.

With reference to FIG. 6, a flowchart of the operation of a reviewer device is illustrated in accordance with a preferred embodiment of the present invention. The process begins and the reviewer logs onto the knowledge base externalization and tracking system (step 602). The process checks the reviewer work queue (step 604) and presents a knowledge entry in the work queue to the reviewer (step 606).

A determination is made as to whether the reviewer approves the knowledge entry (step 608). If the reviewer approves the knowledge entry, the process publishes the knowledge entry to the knowledge base (step 610). Then, a determination is made as to whether the knowledge entry is the last entry in the work queue (step 614).

If the reviewer does not approve the knowledge entry in step 608, the process routes the knowledge entry back to the author (step 612). Thereafter, a determination is made as to whether the knowledge entry is the last entry in the work queue (step 614). If the knowledge entry is the last entry in the work queue in step 614, the process ends; otherwise, the process returns to step 606 to present the next knowledge entry to the reviewer.

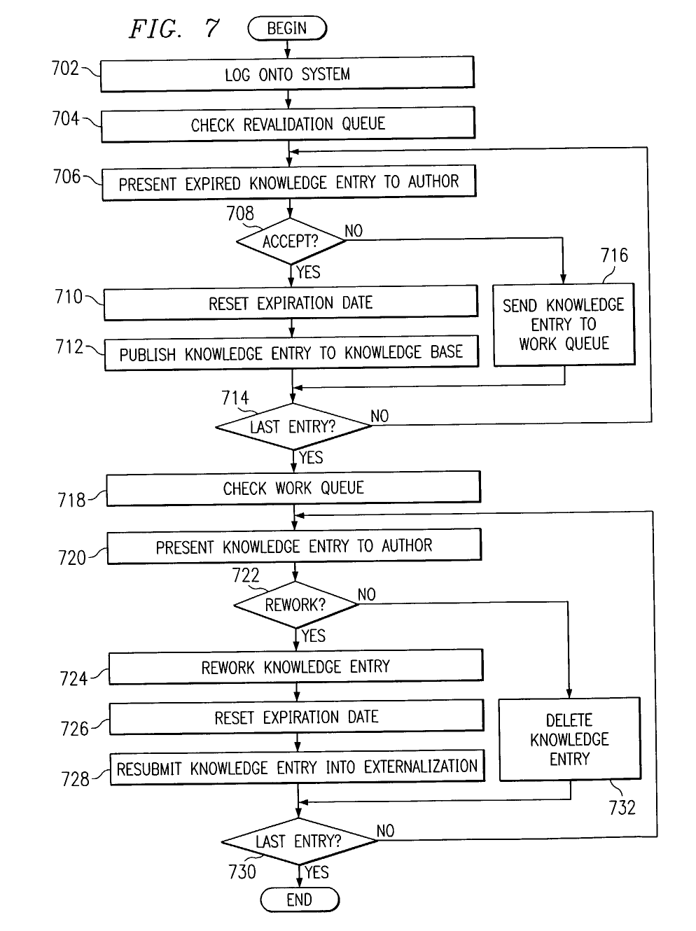

Turning now to FIG. 7, a flowchart of the operation of an author device is illustrated in accordance with a preferred embodiment of the present invention. The process begins and the author logs onto the knowledge base externalization and tracking system (step 702). The process checks the revalidation queue (step 704) and presents an expired knowledge entry from the revalidation queue to the author (step 706).

A determination is made as to whether the author accepts the expired knowledge entry (step 708). If the author accepts the knowledge entry, the process resets the expiration date of the entry (step 710) and publishes the knowledge entry to the knowledge base (step 712). Then, a determination is made as to whether the entry is the last expired knowledge entry in the revalidation queue (step 714).

If the author does not accept the knowledge entry in step 708, the process sends the knowledge entry to the author's work queue (step 716). Then, a determination is made as to whether the entry is the last expired knowledge entry in the revalidation queue (step 714).

If the knowledge entry is not the last entry in the revalidation queue in step 714, the process returns to step 706 to present the next expired knowledge entry to the author. However, if the knowledge entry is the last entry in the revalidation queue, the process checks the work queue (step 718) and presents a knowledge entry in the work queue to the author (step 720).

As stated above, a GUI may be provided that allows the user to switch between a revalidation queue and a work queue. Therefore, the process in FIG. 7 may be modified to allow the user to switch between queues. In other words, the GUI may allow the user to immediately process an entry in the work queue as soon as it is rejected and passed from the revalidation queue to the work queue. Then, the user may be allowed to switch back to the revalidation queue to revalidate the remaining knowledge entries in the queue.

Next, a determination is made as to whether the author wishes to rework the knowledge entry (step 722). If the author wishes to rework the knowledge entry, the process allows the author to rework the knowledge entry (step 724), resets the expiration date of the knowledge entry (step 726), and resubmits the knowledge entry into externalization (step 728). This may be done by publishing the knowledge entry to the knowledge base or submitting the knowledge entry to a reviewer as if it is a newly created entry. Thereafter, a determination is made as to whether the knowledge entry is the last entry in the work queue (step 730).

If the author does not wish to rework the knowledge entry in step 722, the process deletes the knowledge entry from the system (step 732). Then, a determination is made as to whether the knowledge entry is the last entry in the work queue (step 730). If the knowledge entry is the last entry in the work queue in step 730, the process ends; otherwise, the process returns to step 720 to present the next knowledge entry in the work queue to the author.

Thus, the present invention solves the disadvantages of the prior art by providing a knowledge base externalization and tracking system for knowledge entry documents, such as FAQ documents, HAT documents, troubleshooting documents, and the like. The system allows a reviewer to approve knowledge entries before externalization. The present invention also applies an expiration date to knowledge entry documents. When knowledge entries expire, they may be revalidated, thus reducing or eliminating unneeded or obsolete knowledge entries.

The knowledge base externalization and tracking system of the present invention is able to efficiently manage a significant amount of information in a worldwide knowledge base. The system of the present invention is also an extremely scalable and portable management solution. The system is flexible and extensible and can be easily integrated into other existing Web content management systems to produce an enhanced component with knowledge entry handling capabilities. The knowledge base externalization and tracking system may also be programmed using Java to more easily integrate with existing systems.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing a knowledge base, comprising:
receiving a knowledge entry from an author;
determining whether the knowledge entry is approved for externalization; and
in response to the knowledge entry being approved for externalization, time stamping the knowledge entry with an expiration indication and externalizing the knowledge entry to the knowledge base.

2. The method of claim 1, further comprising:
in response to the knowledge entry not being approved for externalization, returning the knowledge entry to the author.

3. The method of claim 1, wherein the step of determining whether the knowledge entry is approved for externalization comprises:
routing the knowledge entry to a reviewer work queue; and
receiving an approval or rejection from the reviewer.

4. The method of claim 1, wherein the step of externalizing the knowledge entry comprises making the knowledge entry widely accessible.

5. The method of claim 1, wherein externalized knowledge entries are accessible using a Web browser.

6. The method of claim 1, further comprising:
identifying an expired knowledge entry in the knowledge base; and
routing the expired knowledge entry to an original author of the expired knowledge entry.

7. The method of claim 1, wherein the knowledge entry is one of a frequently asked questions document, a hints and tips document, and a troubleshooting document.

8. The method of claim 1, further comprising:
generating a report based on knowledge entries in the knowledge base.

9. The method of claim 8, wherein the report is one of a submission report, an externalization report, and a revalidation report.

10. The method of claim 8, wherein the report is generated by at least one of department, individual user, and technology area.

11. A method for managing a knowledge base, comprising:
receiving an expired knowledge entry from the knowledge base, wherein the expired knowledge entry includes an expiration indication;
determining whether the knowledge entry is accepted for externalization; and
in response to the knowledge entry being accepted for externalization, resetting the expiration indication.

12. The method of claim 11, further comprising:
in response to the knowledge entry not being accepted for externalization, removing the knowledge entry from the knowledge base.

13. The method of claim 11, wherein the knowledge base is accessible using a Web browser.

14. The method of claim 11, wherein the step of determining whether the knowledge entry is accepted for externalization comprises:
routing the knowledge entry to an original author of the knowledge entry; and
receiving an acceptance or rejection from the original author.

15. The method of claim 11, wherein the knowledge entry is one of a frequently asked questions document, a hints and tips document, and a troubleshooting document.

16. An apparatus for managing a knowledge base, comprising:
receipt means for receiving a knowledge entry from an author;
determination means for determining whether the knowledge entry is approved for externalization; and
externalization means, in response to the knowledge entry being approved for externalization, for time stamping the knowledge entry with an expiration indication and externalizing the knowledge entry to the knowledge base.

17. The apparatus of claim 16, further comprising:
means for returning the knowledge entry to the author, in response to the knowledge entry not being approved for externalization.

18. The apparatus of claim 16, wherein the determination means comprises:
means for routing the knowledge entry to a reviewer work queue; and
means for receiving an approval or rejection from the reviewer.

19. The apparatus of claim 16, wherein the externalization means comprises means for making the knowledge entry widely accessible.

20. The apparatus of claim 19, wherein externalized knowledge entries are accessible using a Web browser.

21. The apparatus of claim 16, further comprising:
means for identifying an expired knowledge entry in the knowledge base; and
means for routing the expired knowledge entry to an original author of the expired knowledge entry.

22. The apparatus of claim 16, wherein the knowledge entry is one of a frequently asked questions document, a hints and tips document, and a troubleshooting document.

23. The apparatus of claim 16, further comprising:
generation means for generating a report based on knowledge entries in the knowledge base.

24. An apparatus for managing a knowledge base, comprising:
receipt means for receiving an expired knowledge entry from the knowledge base, wherein the expired knowledge entry includes an expiration indication;
determination means for determining whether the knowledge entry is accepted for externalization; and
resetting means, in response to the knowledge entry being accepted for externalization, for resetting the expiration indication.

25. The apparatus of claim 24, further comprising:
removal means, in response to the knowledge entry not being accepted for externalization, for removing the knowledge entry from the knowledge base.

26. The apparatus of claim 24, wherein the knowledge base is accessible using a Web browser.

27. The apparatus of claim 24, wherein the determination means comprises:
means for routing the knowledge entry to an original author of the knowledge entry; and
means for receiving an acceptance or rejection from the original author.

28. The apparatus of claim 24, wherein the knowledge entry is one of a frequently asked questions document, a hints and tips document, and a troubleshooting document.

29. A computer program product, in a computer readable medium, for managing a knowledge base, comprising:
instructions for receiving a knowledge entry from an author;
instructions for determining whether the knowledge entry is approved for externalization; and
instructions for time stamping the knowledge entry with an expiration indication and externalizing the knowledge entry in response to the knowledge entry being approved for externalization to the knowledge base.

30. A computer program product, in a computer readable medium, for managing a knowledge base, comprising:
instructions for receiving an expired knowledge entry from the knowledge base, wherein the expired knowledge entry includes an expiration indication;
instructions for determining whether the knowledge entry is accepted for externalization; and
instructions for resetting the expiration indication in response to the knowledge entry being accepted for externalization.
